(19) United States
(12) Patent Application Publication
(10) Pub. No.: US 2022/0391920 A1
(43) Pub. Date: Dec. 8, 2022

(54) METHOD AND SYSTEM FOR THE AUTOMATIC ASSESSMENT OF INSTALLER COMPANIES FOR FIRE-EXTINGUISHING FACILITIES

(71) Applicant: VdS Schadenverhütung GmbH, Köln (DE)

(72) Inventors: Robert REINERMANN, Köln (DE); Claas BAIER, Köln (DE)

(73) Assignee: VdS Schadenverhütung GmbH, Köln (DE)

(21) Appl. No.: 17/339,052

(22) Filed: Jun. 4, 2021

(51) Int. Cl. G06Q 30/00; G06Q 10/06; A62C 37/50

(52) U.S. Cl. CPC G06Q 30/018; G06Q 10/06398; A62C 37/50

(57) ABSTRACT

A method for the automatic evaluation of installer companies for fire extinguishing facilities is proposed, wherein several criteria for the certification of an installer company are specified, wherein an evaluation metric is specified on the system side, by means of which indications on the fulfillment of the criteria are automatically evaluated and it is determined whether the requirements for a certification of the installer company are fulfilled. Furthermore, a corresponding system for the automatic evaluation of installer companies of fire extinguishing facilities is proposed.

### CROSS-REFERENCES TO RELATED APPLICATIONS

This application is a National Stage filing of International Application PCT/EP 2019/080947 filed Nov. 12, 2019, entitled “Method and System for the Automatic Assessment of Companies that Install Fire-Extinguishing Facilities”, claiming priority to EP 19 156 750.2, filed Feb. 12, 2019, EP 19 162 899.9, filed Mar. 14, 2019, and EP 19 164 542.3, filed Mar. 22, 2019. The subject application claims priority to PCT/EP 2019/080947, EP 19 156 750.2, EP 19 162 899.9, and EP 19 164 542.3, and incorporates all by reference herein, in their entirety.

### BACKGROUND OF THE INVENTION

The present invention relates to a method and a system for automatic evaluation of installer companies, in particular for fire extinguishing facilities.

An installer company in the sense of the present invention is a company that installs fire extinguishing facilities. The installation of a fire extinguishing facility preferably comprises the planning, project planning, assembly, commissioning, inspection, acceptance and/or handover of a fire extinguishing facility to an operator.

### BRIEF SUMMARY OF THE INVENTION

The present invention relates particularly preferably to the certification of installer companies for fire extinguishing facilities, but can in principle also be applied in an advantageous manner to the certification of installer companies for other, in particular safety-relevant facilities. The invention has proven to be particularly advantageous in connection with the certification of installers of fire extinguishing facilities. Advantages are achieved in particular by an increased effectiveness, efficiency and/or reproducibility of the certification process as a result of the invention and an associated potentially improved reliability and safety of erected fire extinguishing facilities.

Fire extinguishing facilities are technical facilities designed to extinguish a fire with an extinguishing agent. In particular, the present invention relates to installers of stationary fire extinguishing facilities or fire extinguishing facilities permanently installed in a plant. Some examples of (stationary) fire extinguishing facilities are sprinkler facilities, water spray facilities, foam facilities, water mist facilities, spark extinguishing facilities, gas extinguishing facilities, inerting facilities and oxygen reduction facilities.

In order for a fire extinguishing facility to function properly, it is of utmost importance that the fire extinguishing facility is installed by a qualified company. To prove their qualification, installer companies can undergo a recognition or certification procedure at a certification body. During the recognition procedure, a large number of criteria are checked and, if the criteria are sufficiently fulfilled, a certificate is finally issued.

One disadvantage of known certification procedures is that a large number of different criteria must be checked in order to obtain a certificate. There are criteria whose fulfillment is essential for obtaining a certificate, as well as criteria with less relevance. If an examination of the criteria reveals that the vast majority of the criteria are fulfilled and only minimal deficiencies are found in the fulfillment of a criterion of lesser relevance, a certificate can usually still be issued.

It is an object in this context is to ensure that a uniform assessment standard is always applied in practice, which is comparable, preferably identical, for all installer companies applying for certification.

It is therefore an object of the present invention to provide a method and a system for the automatic evaluation of installer companies for fire extinguishing facilities as well as a computer program, wherein a uniform evaluation of installer companies for fire extinguishing facilities is ensured, preferably wherein a recognition or certification procedure can be designed in a comprehensible, objective and efficient manner.

The above object is solved by a method according to claim 1, a system according to claim 15 or a computer program according to claim 16. Advantageous further embodiments are the subject of the subclaims.

### BRIEF DESCRIPTION OF THE DRAWINGS

FIG. 1 provides a schematic flow of a method according to the present invention for the testing or certification of installer companies for fire extinguishing facilities, in which the proposed method for the automatic evaluation of the installer companies is carried out; and

FIG. 2 provides a schematic structure of an example of the system according to the present invention.

### DETAILED DESCRIPTION OF THE INVENTION

In the proposed method for the automatic evaluation of installer companies for fire extinguishing facilities, several criteria are defined for the certification of an installer company. For this purpose, an evaluation metric is specified on the system side, by means of which indications on the fulfillment of the criteria are automatically evaluated and, in particular automatically or by means of the evaluation metric, it is determined whether the prerequisites for certification of the installer company are fulfilled.

An automatic evaluation and/or a system-side specification of the evaluation metric are conducive to an objective and uniform evaluation.

“Indications on the fulfillment of a criterion” in the sense of the present invention are in particular indications on whether or to what extent the criterion is fulfilled. The evaluation of an installer company is carried out in particular on the basis of this indications. The indications can be available in various forms, in particular wherein different indications are possible for different criteria. Examples of indications on the fulfillment of a criterion are Boolean indications such as “criterion fulfilled”, “criterion not fulfilled”, “proof available”, “proof not available” or similar, or numerical indications such as “40 units available” or similar.

In an optional first, preferably upstream step, it is determined or checked whether or to what extent the installer company meets the criteria. In other words, indications on the fulfillment of the criteria are created, determined and/or entered in this step. This can be done automatically and/or manually, e.g. by an employee of the certification body or an employee of the installer company. For example, corresponding indications and/or details, such as documents, which serve as proof of fulfillment of the criteria are requested, (electronically) recorded and/or checked by the installer company. Alternatively or additionally, it is possible that at least some criteria are checked directly on site at the installer company and/or during the construction of a fire extinguishing facility by the installer company. An automatic determination of indications for the fulfillment of the criteria can be carried out in that corresponding indications or documents are completely or partially automatically recorded, obtained and/or checked, for example by database retrieval, reading or recording of user inputs.

To check the criteria, one or more catalog(s) of criteria or checklists are preferably provided, in which or with the help of which it can be recorded whether or to what extent the criteria are met.

Criteria catalog(s) can, for example, be available, designed and/or used in paper form and/or in electronic form, in particular as an electronic list or table. If these are available in paper form, they are preferably read in or digitized and fed to the automatic evaluation.

Automatic user guidance can be provided for structured checking of the criteria or recording of indications on fulfillment of the criteria. The automatic user guidance can automatically guide a user, in particular an employee of the certification body or an installer company, through the criteria catalog(s). This improves the completeness of the indications and documents and facilitates a reliable, structured determination or verification of the fulfillment of the criteria.

It is preferable that at least one of the criteria is mandatory for certification. This means that the requirements for certification of the installer company are not fulfilled if the mandatory criterion is not fulfilled. The fulfillment of this at least one criterion that is mandatory for certification is preferably determined automatically. The evaluation metric can be designed accordingly.

A mandatory criterion is in particular a particularly important criterion, the fulfillment of which cannot be waived under any circumstances, for example if the installer company does not have sufficient business liability insurance, if the installer company does not have a certified quality management system, for example according to EN ISO 9001, or if the company's personnel is not sufficiently trained.

Preferably, an evaluation attribute is assigned to each criterion by means of the evaluation metric. The evaluation attribute represents the relevance of the criterion. For example, it can be specified in the evaluation attribute or by means of the evaluation attribute that a criterion is a mandatory criterion. It is also possible that the evaluation attributes of the criteria are formed by numbers or factors or weights in general, wherein particularly important criteria are assigned a high number or a high factor or a higher weight in general and less important criteria are assigned a lower number or a lower factor or a lower weight in general.

According to a further aspect, at least one of the criteria can be partially fulfilled, wherein a fulfillment coefficient is assigned to this criterion during the evaluation by means of the evaluation metric. The fulfillment coefficient can be assigned to the criterion, in particular in addition to the evaluation attribute. The fulfillment coefficient represents to what extent the criterion is fulfilled. In particular, the fulfillment coefficient or its value is determined on the basis of the previously recorded indications on the fulfillment of the criteria.

For example, a criterion may be provided that specifies the quantity and type of spare parts that must be stocked by an installer company. For example, a criterion requiring 50 sprinklers of a certain specification to be stocked may be partially satisfied by not reaching the number of sprinklers required, for example if only 45 sprinklers or 90% of the required 50 sprinklers are stocked. This can be represented by the fulfillment coefficient. Alternatively or additionally, such a criterion may be partially satisfied by the fact that although the quantity of sprinklers stocked is equal to the required quantity of 50, the specification is not equal to the required specification, for example, by the fact that the screen sprinklers have a different nominal opening temperature and/or a different response sensitivity than required according to the criterion. This can alternatively or additionally be represented by the fulfillment coefficient.

It is preferably provided that in the case of only partial fulfillment of the criterion, it is determined that the requirements for certification of the installer company are fulfilled if the fulfillment coefficient fulfills a corresponding fulfillment condition. In the above example, this may be the case, for example, if only 49 instead of the required 50 sprinkler units are stocked.

It is also possible to record one or more secondary conditions, such as a demonstrated order to fully meet the criterion and/or consideration of the secondary condition(s) in the evaluation.

In other words, the fulfillment condition, similar to an evaluation attribute, can take into account the relevance of a partially fulfilled or fulfillable criterion, so that certification can be granted even in the case of minor deficiencies that do not impair the overall qualification of an installer company. The fulfillment condition ensures that this is done in the same way for all installer companies, in particular uniformly and objectively.

According to a further preferred aspect, at least two or more criteria are not mandatory for certification. This means that, in principle, certification of the installer company can also take place if a single one of these criteria is not fulfilled or not completely fulfilled.

The non-mandatory criteria preferably form one or more groups for which an additional condition is specified in the evaluation metric, wherein only if the additional condition is met is it determined that the requirements for certification of the installer company are met. The additional condition can preferably ensure that certification does not occur if an excessive number of criteria are not met or not met completely. The evaluation metric preferably has this additional condition(s), so that by applying the evaluation metric the additional condition is automatically checked.

According to a preferred aspect, a value is calculated on the basis of the evaluation attributes and/or the fulfillment coefficients, wherein the calculated value must reach or exceed a threshold value in order to fulfill the additional condition. This ensures that not too many criteria are only partially fulfilled and/or that one or more criteria of a corresponding relevance are fulfilled to a sufficient degree. In particular, depending on the criteria and their relevance, absolute minimum conditions can be defined in this way which must be met in order to fulfill the requirements for certification, even if the criteria are not in themselves mandatory criteria. In this way, a corresponding margin or goodwill can be implemented in the evaluation metric, but a uniform and objective evaluation standard is ensured.

Alternatively or additionally, the additional condition can preferably only be fulfilled if several criteria of the group are fulfilled together. This can ensure that no certification takes place if none of the non-mandatory criteria is fulfilled.

According to a further preferred aspect, the additional condition can only be satisfied if at least one criterion of a selection of criteria of the group is satisfied. This may ensure that at least one criterion of a selection of criteria that interact with each other is satisfied. The evaluation metric may have a group membership and/or the group membership may be automatically taken into account when applying the evaluation metric.

For example, it may be provided that either a type A device or a type B device must be present for certification. In this case, neither the type A device nor the type B device is mandatory, but certification cannot occur if neither a type A device nor a type B device is present. This may be or may be implemented by the additional condition in the evaluation metric.

The evaluation metrics, the evaluation attributes, the fulfillment coefficients, the secondary condition(s) and/or the additional condition serve to objectify and standardize the procedure. In particular, by means of these means, “expert knowledge” can also be integrated on the system side. In addition, a certain tolerance in the certification or evaluation of the installer companies is implemented through this, especially in combination with the expert knowledge. This is desirable because, although a large number of criteria are specified for evaluation and certification, in practice minor deficiencies in the fulfillment of one or more criteria do not negatively affect the qualification of an installer company, and an overall assessment by an expert would determine that overall, taking all circumstances into account, the installer company meets the requirements for certification.

A significant advantage of the proposed method is that the expertise of an expert, who is able to assess the relevance of individual criteria for the qualification of the installer company as a whole, can be integrated into the system and reproduced automatically, so that a certain “sense of proportion” is ensured during certification, while still realizing a uniform and objective procedure.

In addition, an improvement of the process according to the proposal compared to known methods is that the process is more efficient and simplified, as well as accelerated.

Preferably, but not necessarily, a certificate is automatically generated if it is determined that the requirements for certification of the installer company are met. This accelerates and simplifies the method.

Preferably, the system automatically checks whether sufficient indications are available to determine whether the requirements for certification of the installer company are met. If the check reveals that sufficient indications are not available, a warning message can be issued and/or further continuation of the method can be interrupted, for example. In this way, errors during the test or its failure can be avoided.

According to another preferred aspect, it is possible for the content of a document required to satisfy a criterion to be determined automatically. For example, documents, certificates, deeds or the like can be scanned or otherwise electronically recorded. For example, documents, certificates, deeds, etc. for proving the qualifications of employees can be scanned or otherwise electronically recorded and/or the content of such documents can be determined automatically.

Further, based on the specific content, it can be automatically determined whether the criterion that the document is required to fulfill is met. This is conducive to a fast and efficient process.

It is preferred that the authenticity of a document required to fulfill a criterion is automatically checked. This enables forgeries to be reliably detected and fraud to be prevented.

Furthermore, it is advantageous if a plausibility check is carried out to check whether the indications on the fulfillment of the criteria are plausible. This can prevent or detect errors during entry or recording.

According to another aspect which can also be implemented independently, the present invention relates to a system for automatically evaluating installer companies for fire extinguishing facilities, the system having an evaluation module for evaluating criteria for certifying the installer company. The system or the evaluation module has an evaluation metric by means of which indications on the fulfillment of the criteria can be automatically evaluated. Furthermore, the system or evaluation module is designed to determine whether the requirements for certification of the installer company have been met.

The system is preferably configured to perform the method described above and below.

Particularly preferably, the system is an electronic system or a computer system or a data processing system.

According to a further aspect which can also be implemented independently, the present invention relates to a system for data processing comprising means for carrying out the method described above and below.

According to yet another aspect which can also be implemented independently, the present invention relates to a computer program or computer program product comprising instructions which, when the program is executed by a computer, cause the computer to execute the method described above and/or below.

An “evaluation metric” in the sense of the present invention is, in particular, an evaluation scheme or an evaluation algorithm for evaluating criteria or indications of fulfillment of the criteria. The evaluation metric preferably has various factors or variables, such as evaluation attributes and/or fulfillment coefficients, which are or are assigned to the criteria. The evaluation metric further preferably has an algorithm with which it can be automatically determined whether, on the basis of the (partially) fulfilled criteria or the indications on the fulfillment of the criteria, the requirements for a certification of the established company are fulfilled.

The foregoing and subsequent aspects and features of the present invention may be combined in various ways, but each may also be implemented independently.

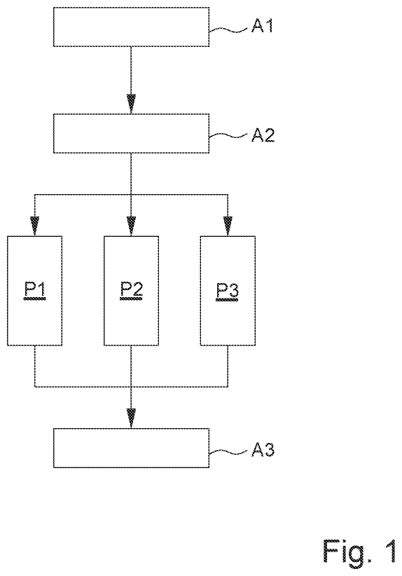

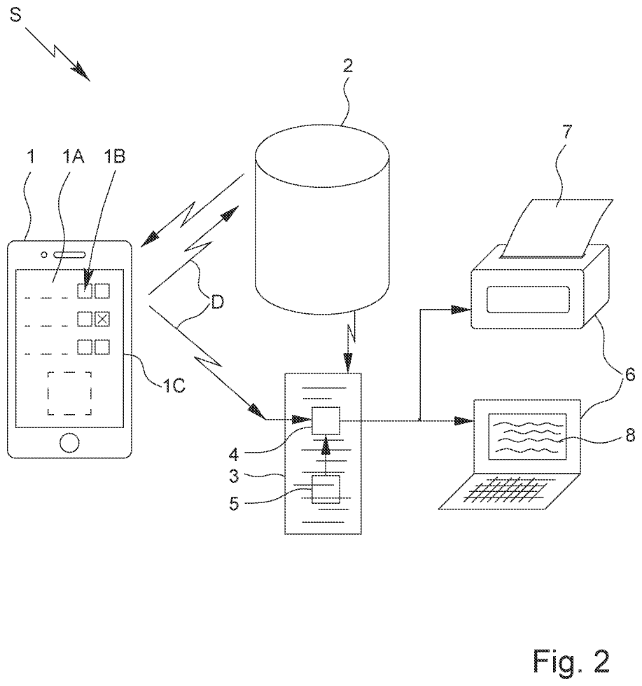

Further aspects, features, advantages and characteristics of the present invention will be apparent from the claims and the following description of preferred embodiments with reference to the drawing. In the drawing shows:
FIG. 1 a schematic flow of a method according to the present invention for the testing or certification of installer companies for fire extinguishing facilities, in which the proposed method for the automatic evaluation of the installer companies is carried out; and
FIG. 2 a schematic structure of an example of the system according to the present invention.

In the following, different aspects of the method according to the invention are first explained by means of non-limiting examples, wherein these aspects can be realized individually and in advantageous ways in different combinations with each other, wherein these aspects and combinations can each form independent objects of the invention, even if this is not explicitly mentioned in the following to avoid repetition.

In the first step A1, an order is issued for the inspection or certification of the installer company. This can be done, for example, by a written application from the installer company by e-mail, letter or similar.

However, it is also possible that the order is placed automatically, for example, if a renewal of an already existing certificate for an installer company is to take place, where a recognition procedure or certification procedure must be gone through again.

In a second step A2, general data of the client or installer company and the type of fire extinguishing system are preferably recorded in a system. For different types of fire extinguishing facilities, different recognition procedures are preferably provided, which differ in the number and type of criteria to be checked. Furthermore, the order type is preferably determined or recorded in the system.

Preferably, different types of orders are envisaged, namely provisional recognition, in which an installer company undergoes a recognition procedure for the first time, and extension of recognition, in which the extension of a certificate already granted is sought, subject to a renewed recognition procedure.

Subsequently, one or more processes P1, P2, P3 are started or executed, in particular depending on the order type.

Process P1 preferably checks whether the documents required for installer recognition or certification have been received or whether sufficient indications are available so that it can be determined whether the requirements for certification have been met. This can be done manually by an administrator or automatically.

In process P2, a preliminary recognition of an installer company is preferably carried out. In process P3, preferably an extension of the recognition is carried out.

When evaluating or testing an installer company, preferably only one of the processes P2 and P3 is performed. Process P1 is preferably carried out in addition to or in parallel with process P2 or P3 or as part of them.

Processes P2 and P3 preferably differ only in the number and type of defined criteria for recognition or certification. Therefore, the following explanations apply in each case to both process P2 and process P3, unless otherwise noted.

Preferably, the processes P1, P2, P3 are each provided with criteria catalogs such as checklists, which show the criteria or in which the criteria are listed. The criteria catalogs or checklists are available, for example, in paper form or in electronic form, in particular in the form of a list or table.

In this context, a criteria catalog or checklist is preferably a list or organized compilation of the criteria, and can therefore be, but does not have to be, a stringing together of the criteria in a particular order.

A criteria catalog or checklist, especially for the P2 process or for preliminary recognition of an installer company, may have one, several or all of the following criteria:
Existence or presentation of an extract from the Commercial Register or the Trade Register,
Existence of a public liability insurance or proof thereof,
Existence of a quality management system, in particular according to ISO 9001, or proof thereof,
Presence or presentation of a bank statement,
Existence or presentation of a maintenance contract or proof thereof,
Existence or presentation of a maintenance contract (installer/operator) or proof thereof,
Existence or submission of an emergency service or emergency service documentation or proof thereof,
Existence or presentation of a delivery commitment or proof thereof,
Existence or submission of an organizational chart or proof thereof,
Existence or presentation of an overview of specialized personnel, in particular one that is proper or complies with specifications, or proof thereof,
Existence or submission of an application for access to a customer portal or proof thereof,
Presence or presentation of a company logo Presence or presentation of a calculation program or proof thereof and/or
Existence or submission of information on affiliated companies.

Alternatively or additionally, a criteria catalog or checklist, especially for a responsible professional, may have one, several or all of the following criteria:
Passing of an examination by the specialist or existence or presentation of proof thereof,
Existence of an employment relationship with a duration of at least 3 months before appointment as responsible specialist or existence or submission of proof thereof,
Employment with recognized installer in the last 24 months or existence or submission of proof thereof and/or
Attending or passing one or more trainings and/or continuing education courses or having or submitting one or more proofs thereof, especially in case of existing qualification.

Alternatively or additionally, a criteria catalog or checklist, particularly for technical documentation, may have one, more, or all of the following criteria:
Existence or presentation of proof that the system is recognized,
Existence or submission of a drawing of one or more demonstration facilities, in particular one that complies with the regulations or specifications, or proof thereof,
Existence of a BMA specialist or proof thereof,
Existence of a stock of spare parts or proof thereof,
Presence of concentration measuring devices or proof thereof and/or
Possibility of access to concentration measuring devices or existence or presentation of proof thereof.

Alternatively or additionally, a criteria catalog or checklist, in particular for further companies in a group of companies, can have one, several or all of the following criteria:
Existence or presentation of a cooperation agreement or proof thereof,
Existence or submission of proof and/or information on the group of companies,
Presence or presentation of a confirmation from the mother or holding company or proof thereof,
Existence or presentation of an equity interest, preferably of at least 75%, or proof thereof and/or
Existence or presentation of a process description or authority to issue instructions or proof thereof.

Alternatively or additionally, a criteria catalog or checklist, in particular for one or more further operating sites, may have one, several or all of the following criteria, preferably where these criteria are provided multiple times, in particular for each (further) operating site:
Existence or presentation of a minimum stockpile or proof thereof or information thereon,
Existence or presentation of planning and project planning or proof thereof or details thereof,
Existence or submission of a demonstration facility or evidence thereof,
Existence or submission of proof and/or details of an installation,
Existence or presentation of proof and/or details of a workshop.
Existence or presentation of proof and/or information on maintenance and/or
Existence or submission of proof and/or information on skilled workers.

The aforementioned criteria and/or catalogs of criteria or checklists may also be used individually and/or in various combinations to form a part of the invention.

In the process P2, P3, it is preferably first checked whether the criteria are fulfilled or which of the criteria are fulfilled. In other words, indications on the fulfillment of the criteria are recorded or created. Subsequently, it is preferably evaluated whether the fulfilled criteria are sufficient for certification of the installer company. The checking of the criteria or the creation of the indications on the fulfillment of the criteria can be carried out by a clerk or automatically.

The test to determine whether the criteria are met can be carried out, for example, on the basis of documents that are to be submitted or have been submitted by the installer company. Alternatively or additionally, it is possible that the test is carried out on site, for example at the installer company itself and/or during the installation of a fire extinguishing facility at a customer of the installer company.

The indications on the fulfillment of the criteria are preferably recorded automatically and/or with technical aids. For this purpose, it can be provided that the indications can be entered or are entered via an input device. Alternatively or additionally, the indications 4 can be read in electronically, for example using imaging processes such as scanning or photographing, and/or by receiving or retrieving it from a server, database or other storage device that provides corresponding information or details.

According to the present invention, the evaluation of whether the fulfilled criteria are sufficient for certification is carried out automatically and/or by means of an evaluation metric specified by the system.

Preferably, the evaluation metric is used to determine whether the requirements for certification of the installer company are met. This is done in particular in process P1, P2 and/or P3.

Particularly preferably, the evaluation metric is automatically applied to the indications on the fulfillment of the criteria. This can be an algorithm or a mathematical operation in which the application of the evaluation metric to the indications on the fulfillment of the criteria leads to a result as to whether a certificate can be granted or not. In an intermediate result, the application of the evaluation metric to the indications of fulfillment of the criteria may lead to a result vector or result matrix, which in turn leads to the result via a transformation. Alternatively or additionally, a transformation may be part of the application of the evaluation metric to the claims.

The result of the application of the evaluation metric is preferably a Boolean variable in the sense that the result has only two states and with these two states clearly differentiates between a positive result, according to which the prerequisites for certification of the installer company are fulfilled, and a negative result, according to which the prerequisites for certification are not fulfilled. Alternatively or additionally, however, the result can also contain further indications, for example details of defects that still need to be rectified for certification or despite certification.

In another optional third step A3, a certificate can be created (automatically) for the installer company if it was previously determined that the requirements for certification are met. Otherwise, no certificate is created. Preferably, the creation of a certificate is prevented if the automatic evaluation shows that the requirements for certification of the installer company are not met. This prevents the system from issuing a certification despite serious deficiencies, which in turn improves the safety not only of the certification procedure but also of the fire extinguishing facilities installed by a certified installer company.

Processes P1, P2 and/or P3 preferably constitute the method for automatic evaluation of installers of fire extinguishing facilities.

The processes P1, P2, P3 can also be formed by a single process and/or be linked to each other.

Preferably, at least one of the criteria is mandatory for certification. This is preferably specified or defined by the system in the evaluation metric. If a mandatory criterion is not met, it is preferably determined that no certificate can be issued for the installer company or that the requirements for certification are not met, in particular regardless of whether and to what extent other criteria are met.

A mandatory criterion could be, for example, that a responsible specialist for the installation of the fire extinguishing system or a specific type of fire extinguishing system is designated at the installer company or that the designated specialist has the required qualification, for example a degree according to level 6 of the European Qualification Framework.

An evaluation attribute is preferably assigned to the criteria by means of the evaluation metric. The evaluation attribute is, in particular, a variable that determines or represents the relevance of the criterion in the evaluation or testing of the qualification of the company for the installation of fire extinguishing facilities.

For example, an evaluation attribute may specify that a criterion is mandatory.

Alternatively or additionally, the evaluation attribute can be formed by a value, a number, a factor, a coefficient or a weighting, in particular where the numerical value corresponds to the relevance of the criterion. Accordingly, particularly important criteria may be assigned high numbers and more subordinate criteria may be assigned low numbers (or vice versa). For example, the evaluation attributes can be formed by numbers from 0 to 1 or from 0 to 100 or the like.

In particular, different types of evaluation attributes may also be provided.

For example, the criteria can be divided into two or more classes, in particular a first class of mandatory criteria and a second class of non-mandatory criteria. Several evaluation attributes, in particular different types of evaluation attributes, can be assigned to the criteria of different classes.

In a preferred aspect, the criteria are each assigned an evaluation attribute in the form of a Boolean variable or the like. Thus, when checking or evaluating the criteria, it can be determined directly if the requirements for certification are not met, namely if a mandatory criterion is not met.

Alternatively or in addition to an evaluation attribute in the form of a Boolean variable, the criteria, in particular the criteria of the second class, can be assigned an evaluation attribute, for example in the form of a numerical value or the like, which represents the relevance of the criterion.

Preferably, at least one of the criteria can be partially met.

Examples of criteria that can be partially met are criteria that specify minimum quantities of execution parts to be stocked. Such a criterion may be partially fulfilled by the fact that the number of execution parts to be stocked does not correspond to or falls below the number specified or required in the criterion. Such a criterion may alternatively or additionally be partially fulfilled by the fact that at least some of the execution parts do not comply with the required specification.

A partially fulfillable criterion is preferably assigned a fulfillment coefficient during the evaluation by means of the evaluation metric, which represents the extent to which the criterion is fulfilled. The fulfillment coefficient can be provided in particular in addition to the evaluation attribute.

The fulfillment coefficient may, for example, have a factor or number or be formed thereby. For example, if the criterion specifies that N parts of a certain specification must be stocked, and the check determines that only M (M<N) parts of this specification are stocked, where M and N denote (natural) numbers, then this criterion is preferably assigned the fulfillment coefficient M/N (i.e. the quotient of M and N) by means of the evaluation metric.

Alternatively or additionally, the fulfillment coefficient may be formed by a number or factor when a specification of stocked parts deviates from the required specification, the factor being a measure of the deviation between the required specification and the actual specification. For example, such a factor may take a value from 0 to 1, with a factor of 1 representing a complete match of the required specification and a factor of 0 representing that the actual specification does not match the required specification in any way.

It is preferably provided that in case of only partial fulfillment of a partially fulfillable criterion, it is determined that the requirements for certification of the installer company are fulfilled if the fulfillment coefficient satisfies a corresponding fulfillment condition.

This can be realized in that the fulfillment coefficient is formed by a number or a factor as described before and a minimum value for the number or the factor is specified in the fulfillment condition.

For example, the partially satisfiable criterion may be that it is required that 50 pieces of a particular type of sprinkler be stocked. In this case, the fulfillment factor may be formed by the quotient M/50, where M denotes the number of sprinklers of the particular sprinkler type actually stocked. As a fulfillment condition, it may be specified that the fulfillment coefficient must be at least the value of 0.9 (corresponding to a minimum quantity of 45 units) in order to fulfill the requirements for certification.

In one aspect of the present invention, at least two criteria are not mandatory for certification or are not mandatory to be met in full, and these criteria form a group. For this group, the evaluation metric preferably specifies an additional condition that must be met in order to satisfy the overall requirements for certification of the installer company.

Preferably, a group of criteria not mandatory for certification is a (real) subset of the class of criteria not mandatory for certification. However, it is also possible that the set of criteria not mandatory for certification is identical to the class of criteria not mandatory for certification.

The additional condition preferably makes it possible to implement a certain tolerance in the evaluation of the qualification of the installer company in the evaluation metric, so that it is still possible to certify the installer company in the case of minor deficiencies such as the incomplete fulfillment of a few and/or rather unimportant criteria. On the other hand, the additional condition prevents certification if too many criteria or certain combinations of criteria are not met.

In the additional condition, requirements for the fulfillment coefficients may be specified, so that certification of the installer company is possible only in case of sufficient fulfillment of the partially fulfillable criteria.

A group of non-mandatory criteria in the aforementioned sense can be formed by a combination of two or more of the following criteria, which have already been mentioned above and are only listed here in brief, in particular with regard to a preliminary recognition of an installer company: Excerpt from the commercial register/excerpt from the trade register, business liability insurance, quality management system (according to ISO 9001), bank statement, maintenance contract, maintenance contract (installer/operator), emergency service documentation, delivery commitment, organization chart, (proper) overview of qualified personnel, application for access to customer portal, company logo and/or calculation program.

Alternatively or additionally, a (further) group of non-mandatory criteria in the aforementioned sense can be formed by a combination of two or more of the following criteria already mentioned above and only given here in brief, in particular with regard to a responsible specialist: Passing of an examination, employment relationship at least 3 months prior to designation, last 24 months in the case of a recognized installer and/or training certificates (if the qualifications are passed).

Alternatively or additionally, a (further) group of non-mandatory criteria in the aforementioned sense can be formed by a combination of two or more of the following criteria, which have already been mentioned above and are only given here in brief, in particular with regard to technical documents: system recognized, drawing of demonstration system available, drawing of demonstration system in order, presence of fire alarm system specialist, spare parts stocking, presence of concentration measuring devices and/or possibility of access to concentration measuring devices.

Alternatively or additionally, a (further) group of non-mandatory criteria in the aforementioned sense may be formed by a combination of two or more of the following criteria already mentioned further above and reproduced here only in key words, in particular with regard to further companies in a group of companies: cooperation agreement, indications on the group of companies, confirmation of the parent company or holding company, equity participation and/or process description or authority to issue directives.

Alternatively or additionally, a (further) group of non-mandatory criteria in the aforementioned sense may be formed by a combination of two or more of the following criteria already mentioned further above and reproduced here only in key words, in particular with regard to further operating facilities: Minimum stock, planning and projecting, demonstration plant, installation, workshop, maintenance, information on skilled workers.

The aforementioned criteria and/or catalogs of criteria or checklists may also be used individually and/or in various combinations to form one or more groups, thus forming in particular a part of the invention.

According to one aspect, based on the evaluation attributes and/or the fulfillment coefficients, a value is calculated that must meet or exceed a threshold value to fulfill the additional condition.

Preferably, the evaluation attributes and/or fulfillment coefficients are each formed by numerical values, for example from 0 to 100 or from 0 to 1, the evaluation attributes and/or fulfillment coefficients forming the variables of a function by means of which the value which must reach or exceed a threshold value in order to fulfill the additional condition is calculated as a function of the evaluation attributes and/or fulfillment coefficients.

According to another aspect of the present invention, the additional condition preferably specifies a minimum number of criteria and/or the additional condition specifies one or more combinations of criteria that must be met or at least sufficiently met to satisfy the additional condition.

According to a further aspect of the present invention, the additional condition can preferably only be fulfilled if at least one criterion of a selection of criteria of the group is fulfilled. In this way, it can be taken into account that, if applicable, different measures are equally suitable for achieving a certain goal, on the basis of which the qualification of an installer company can be evaluated. If several alternative measures for achieving a goal can be considered, these different measures can be represented by different criteria, each of which is not mandatory in itself. The additional condition can then specify that at least one of these alternative criteria must be fulfilled for successful certification. In other words, the possibility is thus created to leave it up to the installer company in certain cases to decide in which way a certain requirement is fulfilled, if in principle various measures can be considered for this purpose.

Preferably, the system automatically checks whether sufficient indications are available to determine whether the requirements for certification of the installer company are met. In particular, the receipt of required or requested documents, on the basis of which the qualification of the installer company is assessed, can be checked automatically or by the system. For example, it can be provided that the required documents are sent by the installer company to a special e-mail address or are uploaded to a special database 2, so that the receipt and/or content of the documents can be checked automatically.

It is possible that a warning will be issued if the available indications are insufficient to determine whether the requirements for certification of the installer company have been met.

According to a preferred aspect of the present invention, it is provided that a particular document must be present according to a criterion. The presence of such a document may be determined automatically. Particularly preferably, such a document is automatically recognized and the authenticity of the document is verified. This can be done, for example, by text recognition and/or structural analysis. Alternatively or additionally, it may be provided that a content of one or more documents contains indications and/or data relating to the fulfillment of a criterion. Such indications and/or particulars may be determined automatically, for example by text recognition or reading of text from such a document. Documents may be digitized for this purpose, for example scanned, photographed or the like. Alternatively or additionally, digital documents can be read in, retrieved and/or received. Subsequently, an analysis or verification can be performed to determine whether and to what extent a criterion is met.

Preferably, based on the automatically determined content of a document, it is automatically determined whether a criterion that a document is required to meet is met.

For example, one criterion may be that a business liability insurance policy with a defined amount of coverage is available. It can then preferably be automatically determined or verified whether a document is available in which the conclusion of a corresponding business liability insurance policy is confirmed.

It is advantageous if the authenticity of a document required to fulfill a criterion is checked automatically. This can be done by determining or checking the composition or structure of the document, by checking characteristic features and/or certain security features such as watermarks, seals or the like. This can be done by checking characteristic features and/or certain security features such as watermarks, seals, etc., by comparing with a reference document and/or by checking an electronic signature. In this way, fraud can be prevented.

Furthermore, a plausibility check is preferably carried out to check whether indications on the fulfillment of the criteria are plausible. In particular, contradictory indications can be identified in this way and errors, for example due to incorrect or incorrectly read-in entries, can be avoided.

For example, it is possible that it was indicated that no required training certificate exists for an employee, although such a training certificate has already been recorded and checked by the system. In this case, a corresponding message can be issued for the purpose of correction or verification.

In a preferred further embodiment of the present invention, a certificate is automatically generated or a certification is automatically granted when the method or system according to the invention determines that the requirements for certification of the installer company have been met.

Quite preferably, the creation of a certificate is prevented, i.e. in particular the production or printing of a certificate, in particular in the form of a document, is prevented if the prerequisites for certification of the installer company are not fulfilled. For this purpose, the creation or production of a certificate is preferably absolutely linked to the system or the implementation of the process, such that a certificate can only be created or produced under the condition that the requirements for the certification of the installer company are fulfilled.

The process is preferably carried out on a system S designed for this purpose or by means of a system S designed for this purpose. The system S is preferably a system S for data processing or a computer system.

FIG. 2 shows an embodiment example of a system S according to the present invention.

Preferably, the system S according to the present invention has an input device 1 for inputting indications 1B for satisfying criteria 1A.

The input device 1 is particularly preferably a smartphone or a tablet or generally a portable input device. However, the input device 1 can alternatively or additionally also be a location-based input device.

The input device 1 may have a display device 1C such as a display. The display device 1C may be touch-sensitive for the purpose of input, so that the indications 1B for fulfilling criteria 1A can be entered via it.

Furthermore, the input device 1 can have a user guidance system. The user guidance can be implemented in the form of an app or a web interface of a server or the like. However, other solutions are also conceivable here.

The user guidance is preferably designed to guide a user, particularly preferably an employee of a certification body or installer company, in a structured manner through the criteria 1A to be fulfilled and, in doing so, to record inputs as indications 1B for the respective criteria 1A and assign them to them. For this purpose, the user guidance preferably displays criteria 1A on the display device 1C and enables the input of the indication 1B corresponding thereto in each case. In this case, the input is preferably recorded by the input device 1 as indication 1B and assigned to the respective criterion 1A.

In principle, it is preferable for data or indications 1B to be entered, in particular via the input device 1, by an employee of a certification body. However, it is also possible that such entries are made by an employee of an installer company or the company to be evaluated.

The system S according to the present invention may have a database 2. This database 2 may provide, in particular supplementary, indications 1B for the fulfillment of the criteria 1A.

Alternatively or additionally, the indications 1B acquired by the input device 1 may be stored completely or partially in the database 2.

The system S according to the present invention may comprise one or more servers 3. The server or servers 3 may be adapted to automatically evaluate the indications 1B or the criteria 1A. In the embodiment example, the server 3 is a stationary and/or central computing device. Alternatively or additionally, however, the server 3 may be a software component and/or a module and/or form part of the database 2 and/or the input device 1.

The server 3 may have or form the database 2.

Preferably, the server(s) 3 and/or the database 2 form(s) a cloud or a cloud system or a part thereof. In particular, the server(s) 3 and/or the database 2 can be stationed at any location and are not necessarily stationed at the certification body.

Preferably, the system S has a processor 4 that is equipped with the proposed evaluation metric 5 and is thereby arranged to verify the requirements for certification of the installer company.

The processor 4 is preferably part of the server 3 of the certification authority.

The system S may have a data interface D for reading in, retrieving and/or receiving indications 1B regarding the fulfillment of the criteria 1A. In this way, the system S can provide the processor 4 with indications 1B acquired by means of the input device 1 or provided by the database 2, which the processor 4 uses as a basis for the evaluation.

The evaluation is carried out with the system S preferably by applying the evaluation metric 5 to the indications 1B for the fulfillment of the criteria 1A or is designed for this purpose. In detail, this is preferably done as previously explained in connection with the method according to the present invention, or the system S is designed for this purpose.

The system S preferably comprises one or more output devices 6 by means of which the result 8 generated by the processor 4 applying the evaluation metric 5 to the indications 1B or criteria 1A can be output and/or the certificate 7 can be generated.

The issuance of the certificate may be subject to the condition that the automatic evaluation of the criteria 1A or indications 1B by means of the evaluation metric 5 has shown that the prerequisite for the certification of the installer company is fulfilled.

In the illustration example, the input device 1 can be coupled to the processor 4 via a preferably wireless data connection D, which is located in a server 3 in the illustration example according to FIG. 2. However, other solutions are also possible here.

Furthermore, it is alternatively or additionally possible that the indications 1B for fulfilling the criteria 1A are transmitted to the database 2 via a preferably wireless data connection D and/or are temporarily stored by means of the database 2. However, it can also be provided here that the database 2 does not have any data connection D with the input device 1 and only provides supplementary indications 1B for fulfilling the criteria 1A.

Preferably, the processor 4 applies the evaluation metric 5 to the indications 1B received or retrieved from the input device 1 and/or the database 2 to satisfy the criteria 1A. Hereby, the result 8 may be generated and output by means of an output device 6. Alternatively or additionally, the generation, in particular the printing, of the certificate 7 is enabled or automatically triggered if it has been automatically determined that the prerequisite for certification of the installer company has been met.

In another aspect, the invention relates to a computer program or computer program product which can also be implemented independently, comprising instructions which, when the program is executed by a computer, cause the computer to perform the method described above.

The computer program or computer program product or part thereof is preferably an app for a tablet or smartphone or the like. by means of which indications 1B on the fulfillment of the criteria 1A can be entered and fed to an evaluation module. By means of the evaluation module, the evaluation metric can be applied to these and/or further indications 1B in order to automatically determine whether the requirements for certification of the installer company are met. The evaluation module may be a software and/or hardware component executing or executable on the processor 4.

Preferably, the system S, the computer program or computer program product, the server 3 or the processor 4 comprises the evaluation module for evaluating the criteria 1A. In this regard, the evaluation module may comprise the evaluation metric 5 and instructions for applying the same to the indications 1B or criteria 1A.

Individual aspects and features of the present invention can be implemented independently, but also in different combinations.

### LIST OF REFERENCE SIGNS

1 Input device
1A Criteria
1B Indications
1C Display device
2 Database
3 Server
4 Processor
5 Evaluation metric
6 Output device
7 Certificate
8 Result
A1 first step
A2 second step
A3 third step
D Data connection
P1 Process
P2 Process
P3 Process
S System

1-16. (canceled)

17. A method for the automatic evaluation of installer companies for fire extinguishing facilities,
wherein several criteria for the certification of an installer company are specified,
wherein an evaluation metric is specified on the system side, by means of which indications on the fulfillment of the criteria are automatically evaluated and it is determined whether requirements for a certification of the installer company are fulfilled.

18. The method according to claim 17,
wherein at least one of the criteria is mandatory for certification, so that it is determined that the requirements for certification of the installer company are not met if this criterion is not met.

19. The method according to claim 17,
wherein an evaluation attribute is assigned to each criterion by means of the evaluation metric.

20. The method according to claim 17,
wherein at least one of the criteria can be partially fulfilled, wherein this criterion is assigned a fulfillment coefficient during the evaluation by means of the evaluation metric in addition to an evaluation attribute which coefficient represents the extent to which the criterion is fulfilled.

21. The method according to claim 20,
wherein if the criterion is only partially fulfilled, it is determined that the conditions for certification of the installer company are fulfilled if the fulfillment coefficient fulfills a corresponding fulfillment condition.

22. The method according to claim 17,
wherein at least two criteria are not mandatory for certification, these criteria forming a group for which an additional condition is specified in the evaluation metric, it being determined that the requirements for certification of the installer company are met only if the additional condition is met.

23. The method according to claim 22,
wherein a value is calculated on the basis of the evaluation attributes and the fulfillment coefficients and the calculated value must reach or exceed a threshold value to fulfill the additional condition.

24. The method according to claim 22,
wherein the additional condition can only be fulfilled if several criteria of the group are fulfilled together.

25. The method according to claim 22,
wherein the additional condition is only satisfiable if at least one criterion of a selection of criteria of the group is satisfied.

26. The method according to claim 17,
wherein a certificate is automatically generated when it is determined that the requirements for certification of the installer company are met.

27. The method according to claim 17,
wherein it automatically checks whether sufficient indications are available to determine whether the requirements for certification of the installer company are met.

28. The method according to claim 17,
wherein the content of a document required to satisfy a criterion is automatically determined, wherein based on the determined content it is automatically determined whether the criterion is satisfied.

29. The method according to claim 17,
wherein the authenticity of a document required to fulfill a criterion is automatically checked.

30. The method according to claim 17,
wherein a plausibility check is performed to determine whether indications on the fulfillment of the criteria are plausible.

31. A system for automatic evaluation of installer companies for fire extinguishing facilities,
wherein the system has an evaluation module for evaluating criteria for certification of an installer company, wherein the system or the evaluation module has an evaluation metric by means of which indications on fulfillment of the criteria can be automatically evaluated, and
wherein the system or evaluation module is designed to determine whether the requirements for certification of the installer company are fulfilled,
wherein the system is configured to carry out the method according to claim 17.

32. A computer program comprising instructions which, when the program is executed by a computer, cause the computer to perform the method of claim 17.
